(19) United States
(12) Patent Application Publication
(10) Pub. No.: US 2005/0061354 A1
(43) Pub. Date: Mar. 24, 2005

(54) Cylindrical bristle floss

(76) Inventor: William Troy Dill III, Sacramento, CA (US)

Correspondence Address: WILLIAM T. DILL III, 5150 FAIROAKS BOULEVARD, SUITE 101-234, CARMICHAEL, CA, 95608, US

(21) Appl. No.: 10/664,245

(22) Filed: Sep. 22, 2003

(51) Int. Cl. A61C 15/00

(52) U.S. Cl. 132/321

(57) ABSTRACT

My invention is the attachment of cylindrical bristles to floss. The idea being the combination of the two shall create cylindrical bristle floss, so anyone could use it to clean between their teeth for oral hygiene. The bristle attachment to floss is my new invention.

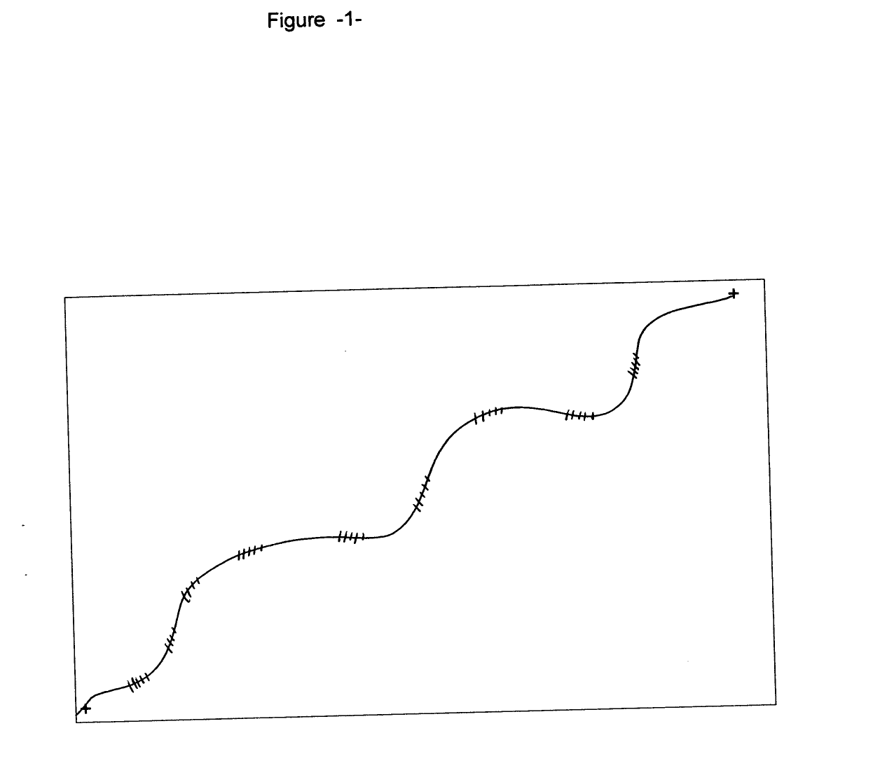

### CROSS REFERENCE TO RELATED APPLICATIONS

Not Applicable

### STATEMENT REGARDING FEDERALLY SPONSERED RESEARCH

Not Applicable

### REFERENCE TO SEQUENCE LISTING

Not Applicable

### BACKGROUND OF INVENTION

The specific nature of my invention is applicable in the field of oral hygiene pertaining to teeth.

### BRIEF SUMMARY OF THE INVENTION

The general idea of my invention is to attach cylindrical bristles to floss, so that the product created can be used to clean between the teeth.

### BRIEF DESCRIPTION OF THE DRAWING

FIG. (1)

The drawing of my invention is to show how the cylindrical bristles are to be attached to the floss and give the general public the concept of my invented product.

### DETAILED DESCRIPTION OF THE INVENTION

The invention is to combine cylindrical bristles to floss. The cylindrical bristles will be applied in such a manner that they are attached to the floss. The product will be cylindrical bristle floss, that can be used in fashion as other flosses to clean in between the teeth for oral hygiene.

1. My claim is that the shape of cylindrical bristles used in combination with floss is my new invention. I state my claim to be the structure of cylindrical bristles and floss to be combined to create my Cylindrical Bristle Floss. In Lloyds U.S. Pat. No. 5,063,948, They claim the attachment of bristles to floss and in Ree's U.S. Pat. No. 6,250,313 B1, they claim attachment of bristles to floss. They never mention in their claims the shape of bristles to be used in combination with floss as in my claim. I could assume they were using any shape they wanted, but until specified we cant assume anything in their patents. The shape of bristles is pertinent in my claim, to distinguish the difference between their inventions and mine. I specify the structural shape of my bristles to be used is cylindrical and the combination of cylindrical bristles and floss to be my invention and it is Cylindrical Bristle Floss. This is how my floss differs from the above mentioned.
